(19) United States
(12) Patent Application Publication
(10) Pub. No.: US 2024/0391534 A1
(43) Pub. Date: Nov. 28, 2024

(54) VEHICLE BOTTOM STRUCTURE

(71) Applicant: Honda Motor Co., Ltd., Tokyo (JP)

(72) Inventors: Kunihiko YOSHITAKE, Saitama (JP); Naoshi KURATANI, Saitama (JP); Kosei TAKEMOTO, Saitama (JP); Yoji SUWA, Saitama (JP); Jun SAWADA, Saitama (JP); Hiroaki KOBAYASHI, Saitama (JP); Ryo Ishibashi, Tokyo (JP)

(73) Assignee: Honda Motor Co., Ltd., Tokyo (JP)

(21) Appl. No.: 18/668,261

(22) Filed: May 20, 2024

(30) Foreign Application Priority Data
May 22, 2023 (CN) 202310576013.2

(51) Int. Cl. B62D 25/20

(52) U.S. Cl. CPC B62D 25/2072

(57) ABSTRACT

A vehicle bottom structure includes a suspension system, a first undercover, and a second undercover. The suspension system includes a trailing arm, and a torsion beam extending along a vehicle width direction. The first undercover is disposed on a front side of the torsion beam in a vehicle front-rear direction. The second undercover is disposed on a rear side of the torsion beam. The first undercover is formed with a rear edge part at a rear edge extending toward the torsion beam along the vehicle front-rear direction. The second undercover includes a front end part at a front end. In a stationary state of a vehicle, an imaginary plane formed by connecting lower surfaces of the rear edge part of the first undercover and the front end part of the second undercover is formed at a position lower than the torsion beam in a vehicle up-down direction.

### CROSS-REFERENCE TO RELATED APPLICATION

This application claims the priority benefit of China application serial no. 202310576013.2, filed on May 22, 2023. The entirety of the above-mentioned patent application is hereby incorporated by reference herein and made a part of this specification.

### BACKGROUND

### Technical Field

The disclosure relates to a vehicle bottom structure.

### Related Art

To allow vulnerable groups such as the elderly, the disabled, and children to also use a sustainable transportation system, efforts have been made to provide a transportation tool with improved energy efficiency. Generally, a vehicle is subjected to a wind resistance during traveling, which increases fuel consumption and reduces the efficiency of energy use. Particularly, there has not been a comprehensive solution for a design of reducing a wind resistance at a vehicle bottom in the art. Thus, there is a need to provide a sustainable transportation system with an aim to improving energy efficiency.

### SUMMARY

A vehicle bottom structure according to an embodiment of the disclosure includes a suspension system, a first undercover, and a second undercover. The suspension system includes a trailing arm that is disposed on an inner side of a rear wheel in a vehicle width direction and a torsion beam that extends along the vehicle width direction to connect the trailing arm. The first undercover is disposed on a front side of the torsion beam in a vehicle front-rear direction. The second undercover is disposed on a rear side of the torsion beam in the vehicle front-rear direction. The first undercover is formed with a rear edge part at a rear edge in the vehicle front-rear direction, and the rear edge part extends toward the torsion beam along the vehicle front-rear direction. The second undercover includes a front end part at a front end in the vehicle front-rear direction. In a stationary state of a vehicle, an imaginary plane formed by connecting lower surfaces of the rear edge part of the first undercover and the front end part of the second undercover is formed at a position lower than the torsion beam in a vehicle up-down direction.

### BRIEF DESCRIPTION OF DRAWINGS

FIG. 1 is a schematic perspective view of a vehicle bottom structure according to an embodiment of the disclosure.

FIG. 2 is a partial bottom view of the vehicle bottom structure in FIG. 1.

FIG. 3 is a cross-sectional view of the vehicle bottom structure in FIG. 1 taken along an A-A sectional line.

FIG. 4 is a cross-sectional view of the vehicle bottom structure in FIG. 1 taken along a B-B sectional line.

FIG. 5 is a schematic bottom view of a vehicle bottom structure according to a modification example of the disclosure.

### DESCRIPTION OF EMBODIMENTS

Embodiments of the disclosure provide a vehicle bottom structure capable of effectively reducing a wind resistance and a lift.

A vehicle bottom structure according to an embodiment of the disclosure includes a suspension system, a first undercover, and a second undercover. The suspension system includes a trailing arm that is disposed on an inner side of a rear wheel in a vehicle width direction and a torsion beam that extends along the vehicle width direction to connect the trailing arm. The first undercover is disposed on a front side of the torsion beam in a vehicle front-rear direction. The second undercover is disposed on a rear side of the torsion beam in the vehicle front-rear direction. The first undercover is formed with a rear edge part at a rear edge in the vehicle front-rear direction, and the rear edge part extends toward the torsion beam along the vehicle front-rear direction. The second undercover includes a front end part at a front end in the vehicle front-rear direction. In a stationary state of a vehicle, an imaginary plane formed by connecting lower surfaces of the rear edge part of the first undercover and the front end part of the second undercover is formed at a position lower than the torsion beam in a vehicle up-down direction.

In an embodiment of the disclosure, a side edge of the first undercover in the vehicle width direction is formed more outward than the trailing arm. A first position, which is more forward than the rear edge of the first undercover in the vehicle front-rear direction, is provided on the side edge. A second position, which is more inward than the trailing arm in the vehicle width direction, is provided on the rear edge. The first undercover is formed with an edge cut part that extends from the first position to the second position.

In an embodiment of the disclosure, the first undercover includes a first uprising wall that is disposed along the edge cut part and protrudes downward in the vehicle up-down direction.

In an embodiment of the disclosure, a second uprising wall is disposed between the first uprising wall and the rear wheel, and the second uprising wall extends more downward than the first uprising wall in the vehicle up-down direction.

In an embodiment of the disclosure, the first uprising wall is installed in a recess on the rear edge of the first undercover, and the recess is recessed upward in the vehicle up-down direction.

In an embodiment of the disclosure, the vehicle bottom structure further includes an extension part formed with the rear edge part. The extension part is installed in a recess on the rear edge of the first undercover, and the recess is recessed upward in the vehicle up-down direction.

In an embodiment of the disclosure, a battery unit is disposed on an upper side of the first undercover in the vehicle up-down direction, and a drive unit is disposed on an upper side of the second undercover in the vehicle up-down direction.

Based on the above, in the vehicle bottom structure of the disclosure, the first undercover and the second undercover do not cover the torsion beam, thereby ensuring a movable range of the torsion beam. Moreover, in the stationary state of the vehicle (in a state in which the vehicle is only subjected to gravity), the lower surfaces of the first undercover and the second undercover are formed at positions lower than the torsion beam, thereby ensuring that the impact of a wind resistance and a lift on the vehicle bottom can be reduced during traveling of the vehicle. Thus, the vehicle bottom structure of the disclosure can effectively reduce a wind resistance and a lift.

To make the above features and advantages of the disclosure more readily understandable, embodiments will be provided below and described in detail with reference to the accompanying drawings.

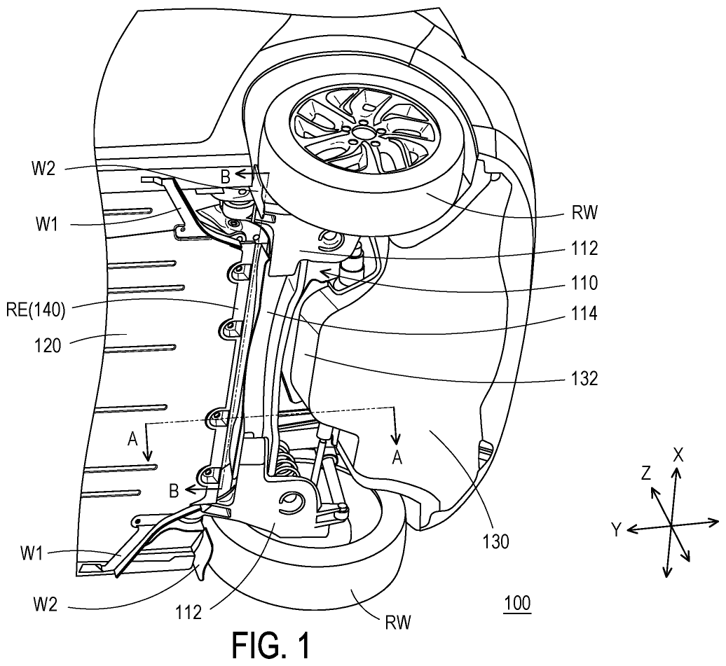

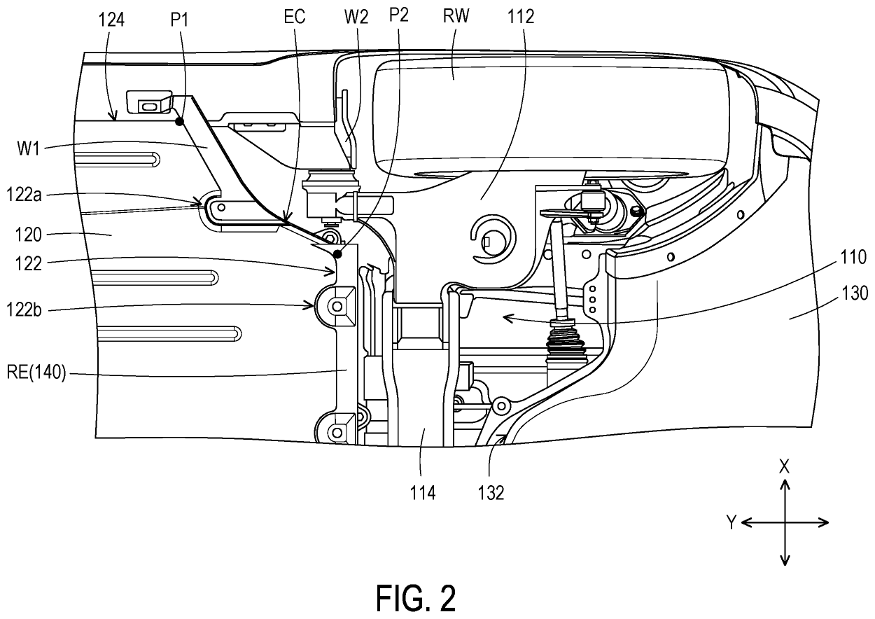

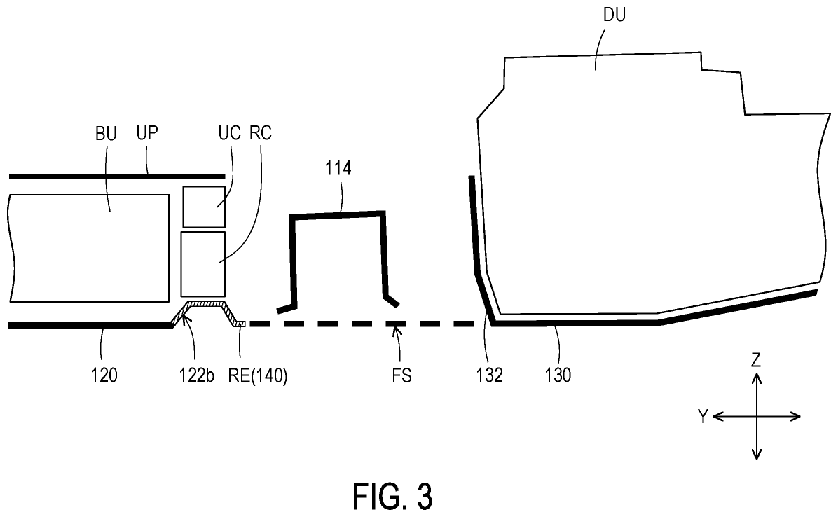

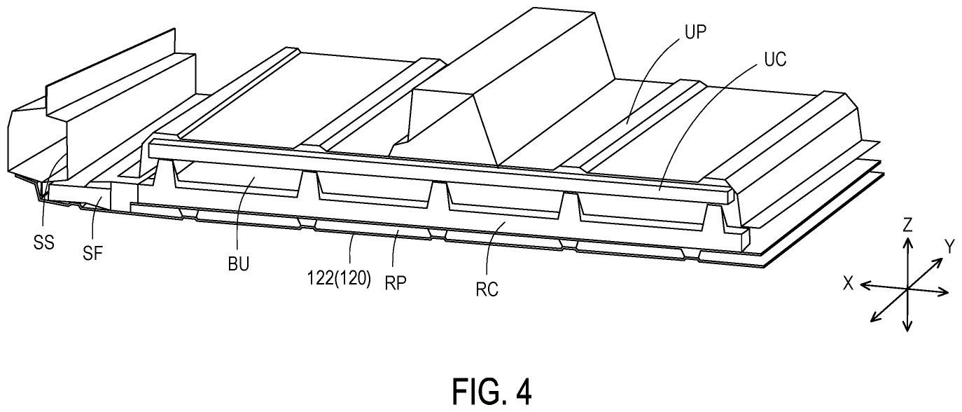

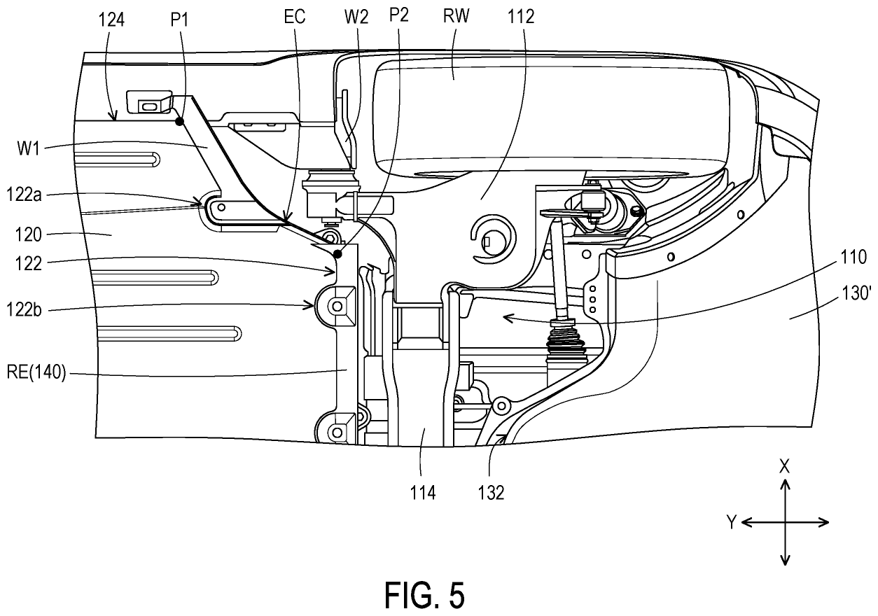

FIG. 1 is a schematic perspective view of a vehicle bottom structure according to an embodiment of the disclosure. FIG. 2 is a partial bottom view of the vehicle bottom structure in FIG. 1. FIG. 3 is a cross-sectional view of the vehicle bottom structure in FIG. 1 taken along an A-A sectional line. FIG. 4 is a cross-sectional view of the vehicle bottom structure in FIG. 1 taken along a B-B sectional line. FIG. 5 is a schematic bottom view of a vehicle bottom structure according to a modification example of the disclosure. In this embodiment, a vehicle bottom structure 100 is, for example, a portion applied to a rear part of a vehicle chassis, and particularly, is configured to cover battery structures such as a drive unit DU and a battery unit BU disposed at a vehicle bottom, but the disclosure is not limited thereto. A vehicle width direction X, a vehicle front-rear direction Y, and a vehicle up-down direction Z in the drawings do not limit the positional relationship of the components in the disclosure, and are only used as directional references. Wherever possible, the same reference signs are used in the drawings and description to represent the same or similar parts. Hereinafter, the vehicle bottom structure 100 of this embodiment will be described with reference to FIG. 1 to FIG. 5.

Referring to FIG. 1 to FIG. 3, in this embodiment, the vehicle bottom structure 100 includes a suspension system 110, a first undercover 120, and a second undercover 130. The suspension system 110 has trailing arms 112 disposed on an inner side of rear wheels RW in the vehicle width direction X, and a torsion beam 114 extending along the vehicle width direction X to connect the trailing arms 112. The trailing arms 112 are disposed on two opposite outer sides in the vehicle width direction X with respect to the torsion beam 114, and the torsion beam 114 is formed in a cap shape opened downward, but the disclosure is not limited thereto. The first undercover 120 is disposed on the front side of the torsion beam 114 in the vehicle front-rear direction Y. The second undercover 130 is disposed on the rear side of the torsion beam 114 in the vehicle front-rear direction Y. Further, the battery unit BU (as shown in FIG. 3) is disposed on the upper side of the first undercover 120 in the vehicle up-down direction Z, and the drive unit DU (as shown in FIG. 3) is disposed on the upper side of the second undercover 130 in the vehicle up-down direction Z. Thus, the first undercover 120 and the second undercover 130 are capable of covering and protecting components such as the battery unit BU and the drive unit DU.

Furthermore, the first undercover 120 is formed with a rear edge part RE at a rear edge 122 in the vehicle front-rear direction Y. The rear edge part RE extends toward the torsion beam 114 along the vehicle front-rear direction Y. The second undercover 130 includes a front end part 132 at a front end in the vehicle front-rear direction Y. Specifically, the rear edge part RE and the front end part 132 are disposed opposite to each other in the vehicle front-rear direction Y, and the torsion beam 114 is disposed between the rear edge part RE and the front end part 132. In a stationary state of the vehicle, an imaginary plane FS (as shown in FIG. 3), which is formed by connecting lower surfaces of the rear edge part RE of the first undercover 120 and the front end part 132 of the second undercover 130, is formed at a position lower than the torsion beam 114 in the vehicle up-down direction Z. That is, height positions of the lower surfaces of the first undercover 120 and the second undercover 130 in the vehicle up-down direction Z are both lower than a height position of the lower surface of the torsion beam 114 in the vehicle up-down direction Z.

Accordingly, in the vehicle bottom structure 100 of this embodiment, the first undercover 120 and the second undercover 130 do not cover the torsion beam 114, thereby ensuring a movable range of the torsion beam 114. Moreover, in the stationary state of the vehicle (a state in which the vehicle is only subjected to gravity), the lower surfaces of the first undercover 120 and the second undercover 130 are formed at positions lower than the torsion beam 114, thereby ensuring that the impact of a wind resistance and a lift on the vehicle bottom can be reduced during traveling of the vehicle. Thus, the vehicle bottom structure 100 of this embodiment can effectively reduce a wind resistance and a lift.

Referring to FIG. 2, in this embodiment, a side edge 124 of the first undercover 120 in the vehicle width direction X is formed more outward than the trailing arm 112. A first position P1, which is more forward than the rear edge 122 of the first undercover 120 in the vehicle front-rear direction Y, is provided on the side edge 124. A second position P2, which is more inward than the trailing arm 112 in the vehicle width direction X, is provided on the rear edge 122. The first undercover 120 is formed with an edge cut part EC extending from the first position P1 to the second position P2. In other words, the first undercover 120 is cut off at a corner side close to the trailing arm 112 to form the edge cut part EC. Thus, interference with the movement of the trailing arm 112 in the vehicle up-down direction Z does not occur, thereby providing a design with a lower vehicle height. In addition, the edge cut part EC is formed in an arc shape, but the disclosure is not limit thereto, and the edge cut part EC may also be in another shape suitable for the movement of the trailing arm 112.

In this embodiment, the first undercover 120 may include a first uprising wall W1. The first uprising wall W1 is disposed along the edge cut part EC and protrudes downward in the vehicle up-down direction Z. Due to the arrangement of the edge cut part EC, the first undercover 120 is relatively uneven at the corner side, which may affect the flow of air during traveling of the vehicle. Thus, by disposing the first uprising wall W1, aerodynamic performance degradation resulting from the edge cut part EC can be alleviated. In addition, a second uprising wall W2 is disposed between the first uprising wall W1 and the rear wheel RW. The second uprising wall W2 extends further downward than the first uprising wall W1 in the vehicle up-down direction Z. The rear wheel RW is disposed inside a wheel cover, and the wheel cover has a deeper recess, which may affect the flow of air. With the arrangement of the second uprising wall W2, aerodynamic performance degradation resulting from the wheel cover can be alleviated.

Further, as shown in FIG. 2 and FIG. 3, in this embodiment, the first uprising wall W1 is installed in a recess 122a on the rear edge 122 of the first undercover 120. The recess 122a is recessed upward in the vehicle up-down direction Z. In addition, the vehicle bottom structure 100 further includes an extension part 140. The extension part 140 extends from the rear edge 122 of the first undercover 120 toward the rear side in the vehicle front-rear direction Y, and is formed with a rear edge part RE. The extension part 140 is installed in a recess 122b on the rear edge 122 of the first undercover 120. The recess 122b is recessed upward in the vehicle up-down direction Z. Thus, when the first uprising wall W1 and the extension part 140 are installed on the first undercover 120, protrusions such as bolts used for fastening and fixing may be accommodated in the recess 122a and the recess 122b without affecting the flow of air, thereby suppressing aerodynamic performance degradation.

Referring to FIG. 3 and FIG. 4, in this embodiment, a lower panel RP and a lower cross member RC are disposed above the rear edge 122 of the first undercover 120. The rear edge 122 of the first undercover 120 is joined with the lower panel RP in the vehicle up-down direction Z. An upper side of the lower panel RP is connected to the lower cross member RC extending in the vehicle width direction X. In addition, an upper panel UP is disposed on the upper side of the battery unit BU in the vehicle up-down direction Z, and is connected to an upper cross member UC extending in the vehicle width direction X. A side member SF is disposed on two opposite outer sides of the battery unit BU in the vehicle width direction X. The side member SF may be, for example, a battery side bracket, but the disclosure is not limited thereto. A side beam SS extending in the vehicle front-rear direction Y is further disposed on the outer side of the side member SF in the vehicle width direction X. The first undercover 120 is joined with the side member SF and the side beam SS in the vehicle up-down direction Z. The method of joining is, for example, fixing by welding or fastening, but the disclosure is not limit thereto.

Referring to FIG. 5, in a modification example, a coverage area of a second undercover 130′ is larger than that of the second undercover 130, which reduces the gap between the trailing arm 112 and the second undercover 130′ and thereby reduces the impact of air on traveling of the vehicle. In other unillustrated embodiments, the shape or the size of the second undercover 130 may also be appropriately adjusted depending on factors such as vehicle height and size, and the disclosure is not limited thereto.

In summary of the above, in the vehicle bottom structure of the disclosure, the first undercover and the second undercover do not cover the torsion beam, thereby ensuring a movable range of the torsion beam. Moreover, in the stationary state of the vehicle (in a state in which the vehicle is only subjected to gravity), the lower surfaces of the first undercover and the second undercover are formed at positions lower than the torsion beam, thereby ensuring that the impact of a wind resistance and a lift on the vehicle bottom can be reduced during traveling of the vehicle. In addition, with installation of structures such as the first uprising wall and the second uprising wall, the disclosure alleviates aerodynamic performance degradation resulting from the edge cut part. Thus, the vehicle bottom structure of the disclosure can effectively reduce a wind resistance and a lift.

Finally, it should be noted that the above embodiments are only used to illustrate, rather than limit, the technical solutions of the disclosure. Although the disclosure has been detailed with reference to the aforementioned embodiments, those skilled in the art should understand that they may still modify the technical solutions recorded in the aforementioned embodiments, or equivalently replace some or all of the technical features; and these modifications or replacements do not depart from the essence of the corresponding technical solutions within the scope of the technical solutions of the embodiments of the disclosure.

What is claimed is:

1. A vehicle bottom structure comprising:
a suspension system, comprising a trailing arm that is disposed on an inner side of a rear wheel in a vehicle width direction and a torsion beam that extends along the vehicle width direction to connect the trailing arm;
a first undercover disposed on a front side of the torsion beam in a vehicle front-rear direction; and
a second undercover disposed on a rear side of the torsion beam in the vehicle front-rear direction, wherein
the first undercover is formed with a rear edge part at a rear edge in the vehicle front-rear direction, and the rear edge part extends toward the torsion beam along the vehicle front-rear direction,
the second undercover comprises a front end part at a front end in the vehicle front-rear direction, and
in a stationary state of a vehicle, an imaginary plane formed by connecting lower surfaces of the rear edge part of the first undercover and the front end part of the second undercover is formed at a position lower than the torsion beam in a vehicle up-down direction.

2. The vehicle bottom structure according to claim 1, wherein
a side edge of the first undercover in the vehicle width direction is formed more outward than the trailing arm,
a first position, which is more forward than the rear edge of the first undercover in the vehicle front-rear direction, is provided on the side edge,
a second position, which is more inward than the trailing arm in the vehicle width direction, is provided on the rear edge, and
the first undercover is formed with an edge cut part that extends from the first position to the second position.

3. The vehicle bottom structure according to claim 2, wherein
the first undercover comprises a first uprising wall that is disposed along the edge cut part and protrudes downward in the vehicle up-down direction.

4. The vehicle bottom structure according to claim 3, wherein
a second uprising wall is disposed between the first uprising wall and the rear wheel, and the second uprising wall extends more downward than the first uprising wall in the vehicle up-down direction.

5. The vehicle bottom structure according to claim 3, wherein
the first uprising wall is installed in a recess on the rear edge of the first undercover, and the recess is recessed upward in the vehicle up-down direction.

6. The vehicle bottom structure according to claim 1, further comprising:
an extension part formed with the rear edge part, wherein
the extension part is installed in a recess on the rear edge of the first undercover, and the recess is recessed upward in the vehicle up-down direction.

7. The vehicle bottom structure according to claim 1, wherein
a battery unit is disposed on an upper side of the first undercover in the vehicle up-down direction, and a drive unit is disposed on an upper side of the second undercover in the vehicle up-down direction.
